(19) United States
(12) Patent Application Publication
(10) Pub. No.: US 2009/0282126 A1
(43) Pub. Date: Nov. 12, 2009

(54) SYSTEM AND METHOD FOR PLAYING DATA OF A REMOTE COMPUTER

(76) Inventors: Kuo-Lung CHANG, Junghe City (TW); Hsing-Yung Wang, Junghe City (TW); Wen-Shiung Wang, Junghe City (TW)

Correspondence Address: SINORICA, LLC, 2275 Research Blvd., Suite 500, ROCKVILLE, MD, 20850, US

(21) Appl. No.: 12/268,566

(22) Filed: Nov. 11, 2008

(30) Foreign Application Priority Data
May 6, 2008 (TW) 97116550

(51) Int. Cl. G06F 15/16

(52) U.S. Cl. 709/219

(57) ABSTRACT

A system for playing data of a remote computer has the remote computer, a network media player and a display. The network media player is able to play data with specified formats. The remote computer uses a data-identifying module to identify formats of data and a data-streaming module to output the data with the specified format to the network media player, or transforms the data to the data with specified format through a data-processing module and continuously outputs the transformed data to the network media player through the data streaming module. The display is connected to the network media player and shows played data.

### BACKGROUND OF THE INVENTION

1. Field of the Invention

The present invention generally relates to a system and a method for playing data of a remote computer, more particularly to a system and a method for playing all data in a remote computer.

2. Description of the Prior Art

With reference to FIG. 1, which illustrates a schematic structure of a system of playing data of a remote computer in prior arts. The system includes a remote computer 10, a network media player 12 and a display 14. Wherein the remote computer 10 is disposed in a study room or a work room, the display 14 is an LCD TV located in a living room, the network media player 12 is disposed around the display 14 and connected to the display 14 and the remote computer 10 through the way of wires or wireless.

The remote computer 10 has a memory 101 and a data-streaming module 103. The data-streaming module 103 has at least one folder 105 in order to store multimedia data 107 with specified format, and the data-streaming module 103 outputs the data 107 with the specified format through a streaming way. The network media player 12 can be a wiring network media player or a wireless network media player, and it is a wireless network media player in FIG. 1. The wireless network media player 12 has a wireless transmission module 121, a multimedia playing module 123, a user interface 125, and a remote control 127, wherein the wireless transmission module 121 transmits data with the remote computer 10, the multimedia playing module 123 is able to play the multimedia data 107 of the folder 105, the user interface 125 shows the default folder 105 in the memory 101 on the display 14, the remote control 127 is to select the multimedia data 107 of the folder 105 and output commands so as to let the multimedia playing module 123 process the multimedia data 107, such commands are as playing, stop, pause, turn-on, turn-off, etc.

While a user plays the data in the remote computer 10, the remote control 127 is used to select the folder 105 on the display 14, then a set of the multimedia data 107 of the folder 105 is selected, and a playing command is output to the remote computer 10. At the moment, the data-streaming module 103 outputs the multimedia data 107 to the network media player 12 through the streaming way, continuously the multimedia playing module 123 plays the multimedia data 107 and outputs the multimedia data 107 to the display 14.

According to the mention above, the disadvantages of the prior art are listed below:
a. The image process function of the network media player of prior arts is not as good as a regular computer, thus the prior network media player can only play data with specified formats, which are normally compatible to the prior network media player. Therefore, data stored in the remote computer and not compatible to the prior network media player are not played.
b. The user interface provided by the prior network media player is only connected to the folder of the specified position of the remote computer, and data with specified formats must be stored in the folder; otherwise the data are not selected by the user.
c. The prior network media player provides a graphical user interface (GUI) to the user. The operations to the GUI are not as easy as file manager of Windows, so that additional time to learn must be taken.

To figure out the disadvantages may be an important issue to the persons skilled in the arts in order to develop a system for playing the data of a remote computer and its method. Further that, the system not only plays data with different formats, but also reads the data of all the folders of the remote computer.

### SUMMARY OF THE INVENTION

The primary objective of the present invention is to provide a system and a method for playing data of a remote computer in order to play all formats of all data of all folders of the remote computer.

The system of the invention comprises the remote computer, a network media player and a display.

The remote computer comprises a memory, a data-identifying module, a data-streaming module, a data-processing module, and a first pointing device, wherein the memory is for storing a plurality of data, the data-identifying module is for identifying formats of the data inside the memory, the data-streaming module outputs data with a specified format of the formats through a streaming way according to identification results from the data-identifying module, the data-processing module transforms data without the specified format into the data with the specified format, and then delivers the data with the specified format to the data-streaming module, the first pointing device is for selecting or triggering the data of the memory.

The network media player can be a wiring network media player or a wireless network media player. For the preferred embodiment of the present invention, it is a wireless network media player. Such that, the network media player comprises a wireless transmission module, a multimedia playing module, a second pointing device, and a pointing control module. Wherein the wireless transmission module transmits the data with the remote computer, the multimedia playing module is for playing the data with the specified format, the second pointing device is for outputting a command of selecting or triggering, the pointing control module is for receiving the command from the second pointing device and generating a corresponding command to operate the first pointing device, the display is connected to the network media player and shows the data played by the multimedia playing module.

The method for playing the system of the present invention comprises the steps of: selecting the data of the remote computer through the second pointing device; identifying whether the selected data conform with the data with the specified format; if yes, the data being transferred to the multimedia playing module through the streaming way for playing; otherwise, the data being opened in the remote computer; transforming the opened data in the remote computer to conform with the data with the specified format, which is played by the multimedia playing module; and delivering the transformed data to the multimedia playing module through the streaming way for playing.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic structure of a system of playing the data of a remote computer in prior arts;

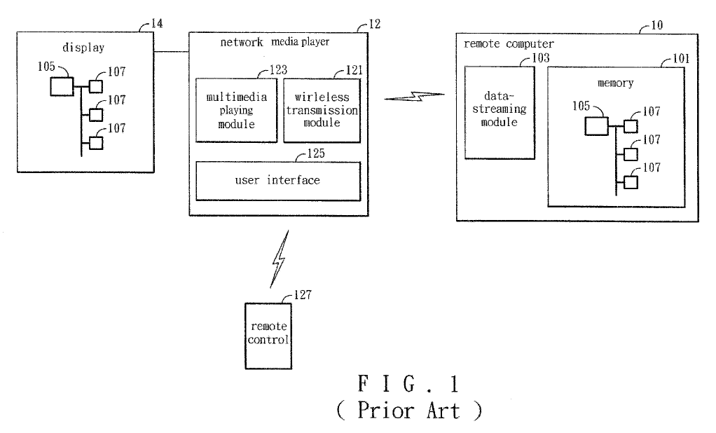

FIG. 2 illustrates a schematic view of a system for playing the data of a remote computer of the present invention;

FIG. 3 illustrates the steps of the flow chart of the method for playing the system of the present invention;

FIG. 4 illustrates the steps of the flow chart of transforming data without specified format to data with specified format of the present invention; and

FIG. 5 illustrates a schematic view of presenting a whole screen and an image area of the remote computer.

### DETAILED DESCRIPTION OF THE INVENTION

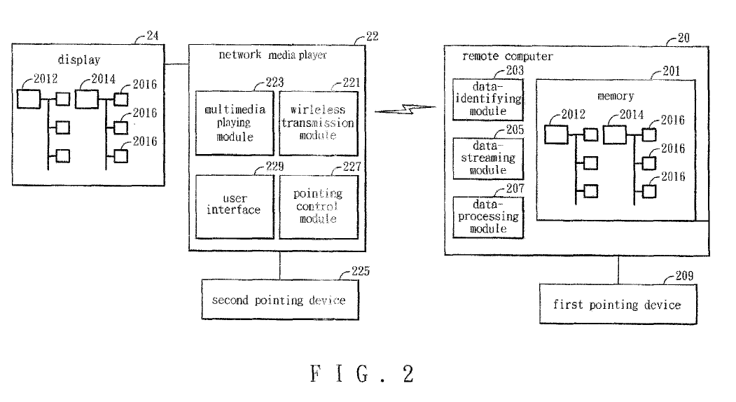

With references to FIG. 2, which illustrates a schematic view of a system for playing data of a remote computer of the present invention. The system includes a remote computer 20, a network media player 22 and a display 24. Wherein the remote computer 20 is disposed in a study room or a work room, the display 24 is an LCD TV located in a living room, the network media player 22 is disposed around the display 24 and connected to the display 24 and the remote computer 20 through the way of wires or wireless.

The remote computer 20 includes a memory 201, a data-identifying module 203, a data-streaming module 205, a data-processing module 207, and a first pointing device 209; wherein the memory 201 has a plurality of folders, which are at least one specified format folder 2014 and one file manager folder 2012, the file manager folder 2012 stores a plurality of formats, such as multimedia data, file data, etc., and the specified format folder 2014 stores data 2016 with specified format, the data 2016 support the network media player 22, so that the data 2016 are played in the network media player 22 directly.

The data-identifying module 203 identifies whether the data in the memory 201 conform with the data 2016 with the specified format, the data-streaming module 205 outputs the data 2016 with the specified format directly through a streaming way according to the results from the data-identifying module 203. The data-processing module 207 transforms data without the specified format to the data 2016 with the specified format, and then the transformed data are delivered to the data-streaming module 205 for outputting in the streaming way, the first pointing device 209 is to select or trigger the data of the memory 201.

The network media player 22 can be a wiring network media player or a wireless network media player. For the preferred embodiment of the present invention, it is a wireless network media player. Such that, the network media player 22 includes a wireless transmission module 221, a multimedia playing module 223, a second pointing device 225, a pointing control module 227, and a user interface 229. Wherein the wireless transmission module 221 transmits data of the remote computer 20, the second pointing device 225 is for outputting a command of selecting or triggering, the pointing control module 227 is for receiving the command from the second pointing device 225 and generating a corresponding command to operate the first pointing device 209, the user interface 209 shows the folders of the memory 201 on the display 24 and includes at least one specified format folder 2014 and one file manager folder 2012, such folders are corresponding to the remote computer 201, therefore a user is able to select or trigger either folder shown on the display 24 through the second pointing device 225, and the second pointing device 225 can be a mouse or a remote control, the display 24 is connected to the network media player 22 and shows the data played by the network media player 22.

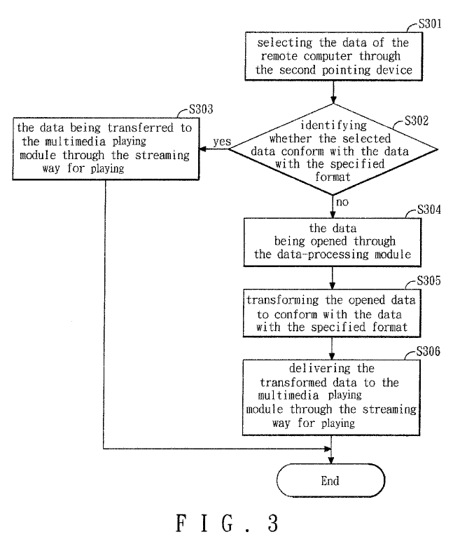

With reference to FIG. 3, which illustrates the steps of the flow chart of the method for playing the system of the present invention. The method includes the steps of: (S301) selecting the data of the remote computer through the second pointing device, wherein the data of the remote computer are presented on the screen of the display; (S302) identifying whether the selected data conform with the data with the specified format through the data-identifying module; (S303) if yes, the data being transferred to the multimedia playing module through the streaming way for playing; (S304) otherwise, the data being opened in the remote computer through the data-processing module; (S305) transforming the opened data in the remote computer to conform with the data with the specified format, which is played by the multimedia playing module; and (S306) delivering the transformed data to the multimedia playing module through the streaming way for playing.

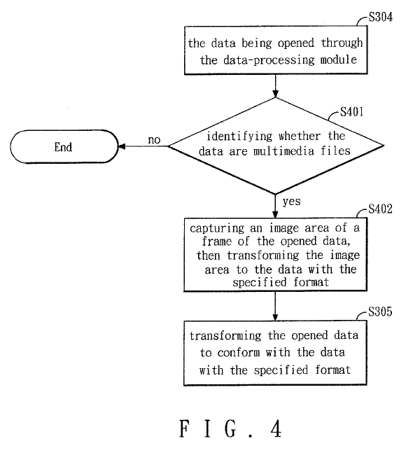

With reference to FIG. 4, since the opened data in (S304) may be a multimedia file that can be played by the remote computer, or are other files that cannot be played, such that, some further steps may be proceeded before (S305) and include the steps of: (S401) identifying whether the data are multimedia files, which are played by the remote computer; if yes, (S402) capturing an image area of a frame of the opened data presented on the remote computer, then compressing and transforming the image area to the data with the specified format; otherwise, directly compressing and transforming the frame to the data with the specified format.

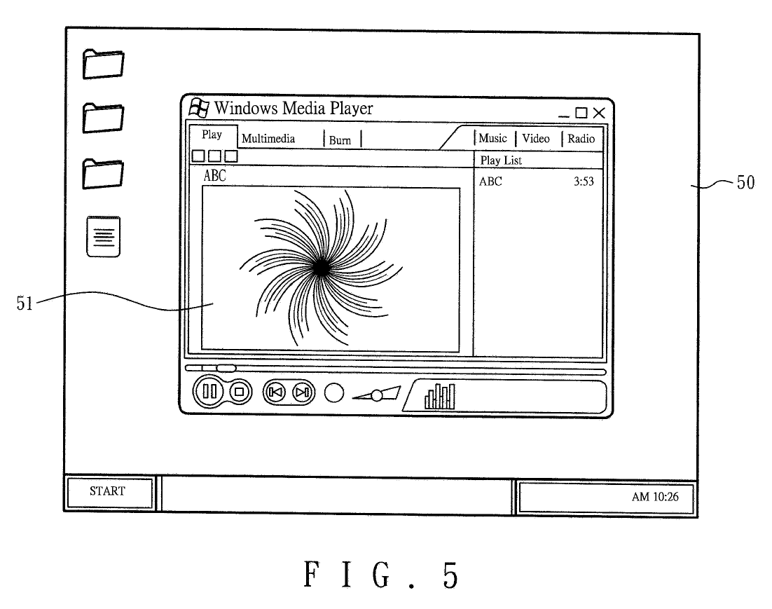

With reference to FIG. 5, the captured image area in (S402) is not as a whole frame 50 presented on the remote computer and only an image area 51 of the whole frame 50. Hence, even the selected data are multimedia data without the specified format, the frame of the display is only the image area 51 and not the whole frame 50. The reason is that only the image area in the remote computer is the object frame of the user.

According to the mention above, the present invention has the advantages as follows:
(a) The present invention is able to play all data in the remote computer, the data can be either with the specified format that are played by the network media player or without the specified format that are not played by the network media player. The data without the specified format are opened by the remote computer first, and then transformed to the data with the specified format.
(b) The user interface is able to provide a function for selecting the data in the remote computer. This is totally different than the prior art only selects the multimedia data stored in the specified folders.
(c) The present invention plays the data in the remote computer through a mouse or a remote control. That is, the user remotely controls the remote computer, but the actual operation is the same as that the user is in front of the computer.
(d) If selected data are multimedia data, no matter what the data with the specified format can be played by the network media player or the data without the specified format cannot be played by the network media player, the present invention is able to play above data without adding new equipment.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A system for playing data of a remote computer comprising:
the remote computer further comprising:
a memory for storing a plurality of data;
a data-identifying module for identifying formats of the data inside the memory;
a data-streaming module outputting data with a specified format of the formats through a streaming way according to identification the results from the data-identifying module;
a data-processing module for transforming data without the specified format into the data with the specified format, and then delivering the data with the specified format to the data-streaming module; and
a first pointing device for selecting or triggering the data of the memory;
a network media player comprising:
a wireless transmission module for transmitting the data of the remote computer wirelessly;
a multimedia playing module for playing the data with the specified format;
a second pointing device for outputting a command of selecting or triggering; and
a pointing control module for receiving the command from the second pointing device and generating a corresponding command to operate the first pointing device; and
a display connected to the network media player for showing the data played by the multimedia playing module.

2. The system for playing data of the remote computer according to claim 1, wherein the data-processing module opens the data without the specified format first, presents the data with a frame on the remote computer, and then transforms the frame to the data with the specified format.

3. The system for playing data of the remote computer according to claim 2, wherein the data without the specified format is a multimedia file, the data-processing module captures an image area of the frame, and then compresses and transforms the image area to the data with specified format.

4. The system for playing data of the remote computer according to claim 1, the network media player further comprising a user interface shown on the display, the user interface comprising at least one specified format folder and one file manager folder, a user being able to select the data in either folder based on the second pointing device.

5. The system for playing data of the remote computer according to claim 1, wherein the first pointing device and the second pointing device are two mice.

6. The system for playing data of the remote computer according to claim 1, wherein the first pointing device is a mouse and the second pointing device is a remote control.

7. A method for playing the system in claim 1 comprising the steps of:
(a) selecting data of the remote computer through the second pointing device;
(b) identifying whether the data conform with the data with the specified format;
(c) if yes, the data being transferred to the multimedia playing module through the streaming way for playing, otherwise, the data being opened in the remote computer;
(d) transforming the opened data in the remote computer to conform with the data with the specified format, which is played by the multimedia playing module; and
(e) delivering the transformed data to the multimedia playing module through the streaming way for playing.

8. The method according to claim 7, wherein step (d) further comprises the steps of:
(d1) identifying whether the data are multimedia files;
(d2) if yes, capturing an image area of a frame of the opened data presented on the remote computer, then compressing and transforming the image area to the data with the specified format, otherwise, directly compressing and transforming the frame to the data with the specified format.
